(19) United States
(12) Patent Application Publication
(10) Pub. No.: US 2011/0220589 A1
(43) Pub. Date: Sep. 15, 2011

(54) FLUID TREATMENT APPARATUS, A FLUID TREATMENT SYSTEM AND A METHOD FOR PRODUCING A FLOW OF FLUID COMPRISING OZONE

(75) Inventor: Albert Martin SCHEFFER, Zelhem (NL)

(73) Assignee: Verhoeve Milieu B.V., Dordrecht (NL)

(21) Appl. No.: 13/046,942

(22) Filed: Mar. 14, 2011

Related U.S. Application Data
(60) Provisional application No. 61/313,990, filed on Mar. 15, 2010.

(51) Int. Cl. C02F 1/78; B01D 37/00; B01D 35/00

(52) U.S. Cl. 210/760; 210/150

(57) ABSTRACT

A fluid treatment apparatus provided with a diffuser, the diffuser comprising a porous wall and an inlet coupled to an ozone tube to provide ozone to the porous wall, is disclosed. The apparatus is constructed to, in use, provide a flow of fluid along the surface of the porous wall and provide a flow comprising ozone to the porous wall via the ozone tube. The ozone will be added through the porous wall to the flow of fluid. The apparatus may have a fluid guidance member having an inlet port to let fluid to be treated into the apparatus and an outlet port to let treated fluid out of the apparatus and the diffuser is positioned in between the inlet and the outlet.

This application claims the benefit of priority from U.S. Provisional Patent Application No. 61/313,990, filed Mar. 15, 2010, the content of which is incorporated herein by reference in its entirety.

The invention relates to a fluid treatment apparatus provided with a diffuser.

A fluid treatment apparatus may be used for cleaning fluids, for example, water that is contaminated with various contaminants. The contaminants may be organic contaminants such as hydrocarbon including chlorinated hydrocarbon and aromatic hydrocarbon. The contaminants may be provided to the water during use of the water in a process or the contaminants may be located in the soil and washed out by the water present in the subsurface. Water may be used in the oil and gas industry to fracture the shale deposits in which gas and oil may be recovered. The water may be contaminated with oil residues after fracturing and may need cleaning as well.

An advanced oxidation process (AOP) may refer to a chemical treatment process designed to remove organic and inorganic materials in waste water by oxidation with: ozone, hydrogen peroxide, oxygen, or air. AOP may be useful for cleaning biologically toxic or non-degradable materials such as aromatics, pesticides, petroleum constituents, and volatile organic compounds in waste water. The contaminant materials may be converted to a large extent into stable inorganic compounds such as water, carbon dioxide and salts. A goal of the waste water purification by means of AOP is the reduction of the chemical contaminants and the toxicity to such an extent that the cleaned waste water may be reintroduced into a receiving stream or into a conventional sewage treatment.

European patent application publication no. EP1021377 discloses a method of cleaning water by injecting a pressurized flow of hydrogen peroxide and ozone into a flow of contaminated water. The hydrogen peroxide and ozone may oxidize the contaminants.

It is desirable, for example, to provide an improved fluid treatment apparatus.

According to an embodiment of the invention, there is provided a fluid treatment apparatus provided with a diffuser, the diffuser comprising a porous wall and an inlet coupled to an ozone tube to provide ozone to the porous wall, wherein the apparatus is constructed to, in use:
provide a flow of fluid along the surface of the porous wall;
provide a flow comprising ozone to the porous wall via the ozone tube; and
add the ozone through the porous wall to the flow of fluid.

According to a further embodiment of the invention, there is provided a fluid treatment system comprising:
a reservoir that receives fluid, the reservoir comprising:
   an inlet that receives the fluid,
   at least one chamber, and
   an outlet to discharge the treated fluid from the reservoir;
a fluid treatment apparatus to produce a fluid flow comprising ozone that is fed into the reservoir, the fluid treatment apparatus having a diffuser, the diffuser comprising a porous wall and an inlet coupled to an ozone tube to provide ozone to the porous wall,
wherein the apparatus is constructed to, in use:
provide a flow of fluid along the surface of the porous wall;
provide a flow comprising ozone to the porous wall; and
add the ozone from the porous wall to the flow of fluid.

According to a further embodiment of the invention, there is provided a method for producing a flow of fluid comprising ozone, the method comprising:
providing a flow of fluid along the surface of a porous wall of a diffuser; and
providing a flow comprising ozone to the porous wall; and
adding the ozone from the porous wall to the flow of fluid.

Embodiments of the invention will now be described, by way of example only, with reference to the accompanying schematic drawings in which corresponding reference symbols indicate corresponding parts, and in which:

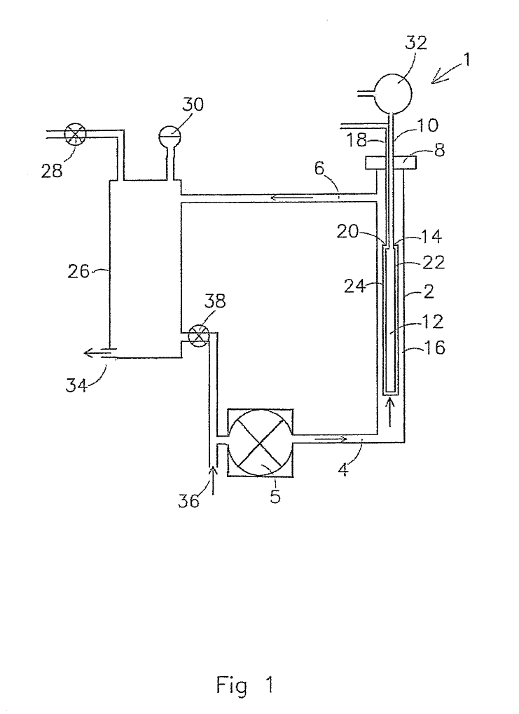

FIG. 1 discloses a fluid treatment apparatus according to an embodiment of the invention; and

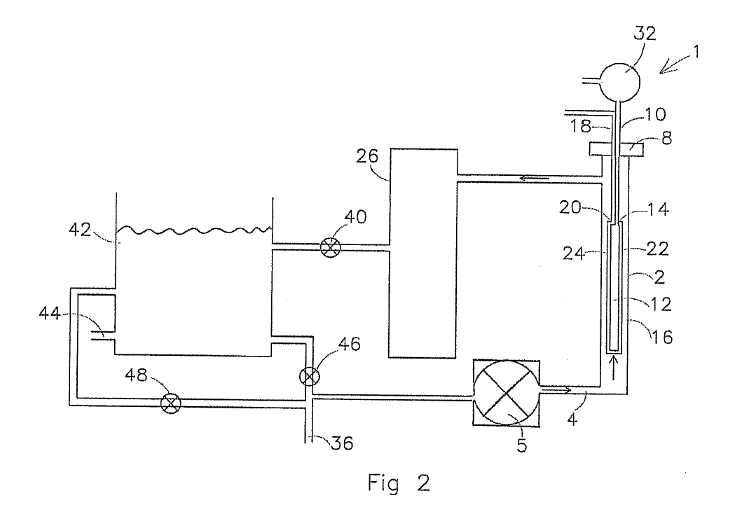

FIG. 2 discloses a further fluid treatment system according to an embodiment of the invention.

FIG. 1 discloses an apparatus according to an embodiment of the invention. The fluid treatment apparatus 1 comprises a casing 2 functioning as a fluid guidance member and having an inlet port 4 to let fluid (water) to be treated into the casing 2 from a pump 5 and inlet 36, an outlet port 6 to let fluid out of the casing 2, and 15 a portion 8 that receives an ozone tube 10. The apparatus 1 further comprises a diffuser 12, disposed in the casing 2, the diffuser 12 is provided with one or more porous walls. The diffuser 12 is disposed in an axial relationship with an inner surface of the casing 2, the diffuser 12 having an inlet 14 coupled to the ozone tube 10. The porous wall may have a pore size diameter that corresponds to a desired bubble size of bubbles that may be released in the flow of fluid from the fluid treatment apparatus.

The apparatus further comprises an ozone addition zone 16 between the diffuser 12 and the outer casing 2 to add a gas comprising ozone to the fluid flowing from the inlet 36 to the outlet 6 along the diffuser 12. A hydrogen peroxide tube 18 is provided through the portion 8 that receives the ozone tube 10 and is coupled to a second inlet 20 on the diffuser 12 to provide hydrogen peroxide to the diffuser 12. The diffuser 12 has a pore size diameter that corresponds to a desired bubble size of bubbles that in use may be released in the fluid. The diffuser 12 comprises a first porous wall 22, e.g. with a cylindrical shape, that receives an ozone tube 10 and a second porous wall 24, e.g. with a cylindrical shape, which surrounds the first porous wall 22 that receives between the first and second porous wall a hydrogen peroxide tube 18. The ozone tube 10 may also be provided between the first and second porous walls and the hydrogen peroxide tube may also be provided to the first porous wall.

The outer size of the diffuser is approximately in a range of about 0.7 to 0.9 of the inner size of the casing 2. The outer size of the diffuser 12 may desirably be approximately 0.75 of the inner size of the casing 2. The pump 5 may pump the liquid (e.g., water) with a speed of larger than or equal to 2 meters per second over the diffuser 12. The Reynolds number for the flow of the liquid (e.g., water) over the filter may be larger than 10,000. The filter may be a micro porous stainless steel or plastic. The pore size diameter of the porous wall of the diffuser 12 may be less than 10 microns. The outlet 6 may be connected to a pressure tank 26 to store treated fluid for a while at a gauge pressure larger than or equal to 2 barg, for example larger than or equal to 3 or 4 barg. The pressure tank 26 may have a gas relief valve 28 to allow gas to escape from the pressure tank 6. The pressure tank may be provided with a pressure sensor 30. From the pressure tank 26 the fluid may be fed along the diffuser again via valve 38 or it may be clean enough so that it may be discharged in, for example, the sewage via tank outlet 34.

The ozone in the system may be provided by ozone generator 32, which can make ozone out of air or oxygen. The apparatus may produce bubbles of ozone coated with hydrogen peroxide which are distributed through the flow of fluid e.g. water. The apparatus may also be used to distribute only ozone or only hydrogen peroxide through the flow of fluid e.g. water.

FIG. 2 discloses a further system according to an embodiment of the invention. The fluid to be treated may enter the system via inlet 36 and may be directed to the fluid treatment apparatus 1 via pump 5 or may enter an atmospheric reservoir 42 via valve 48. If the fluid enters the fluid treatment device 1 it will be provided with ozone and/or peroxide as described above with respect to FIG. 1 at a pressure of, for example, 3 to 4 barg and via outlet 6 the fluid will be brought to a pressure tank 26. At pressure tank 26, the fluid is kept at an alleviated pressure, for example 2 to 3 barg for a while. The fluid can be transported from the pressure tank 26 via valve 40 to an atmospheric reservoir 42 where the gas dissolved in the liquid can escape to the atmosphere. After treatment the fluid can be discharged to, for example, the sewage via atmospheric reservoir outlet 44 or may be recirculated in the treatment apparatus 1 via the valve 46 and pump 5. If the fluid is clean enough, the fluid (water) may be discharged via outlet 44 to, for example, the sewage. In an embodiment, the reservoir 42 comprises a plurality of baffled chambers, with at least one of the chambers receiving a flow of fluid comprising ozone from the fluid treatment apparatus.

The description are intended to be illustrative, not limiting. Thus it will be apparent to one skilled in the art that modifications may be made to the invention as described without departing from the scope of the claims as set out below.

1. A fluid treatment apparatus provided with a diffuser, the diffuser comprising a porous wall and an inlet coupled to an ozone tube to provide ozone to the porous wall, wherein the apparatus is constructed to, in use:
provide a flow of fluid along the surface of the porous wall,
provide a flow comprising ozone to the porous wall via the ozone tube, and
add the ozone through the porous wall to the flow of fluid.

2. The fluid treatment apparatus of claim 1, comprising a fluid guidance member having an inlet port to let fluid to be treated into the apparatus and an outlet port to let treated fluid out of the apparatus and the diffuser is positioned in between the inlet and the outlet.

3. The fluid treatment apparatus of claim 2, wherein the fluid guidance member comprises a casing and the diffuser is disposed within the casing in an axial relationship with an inner surface of the casing and the casing forms an ozone addition zone between the diffuser and the casing to add ozone to the fluid flowing from the inlet to the outlet along the porous wall.

4. The fluid treatment apparatus of claim 3, wherein the size of the diffuser is approximately in a range of about 0.7 to 0.9 of the inner size of the casing.

5. The fluid treatment apparatus of claim 3, wherein the size of the diffuser is approximately 0.75 of the inner size of the casing.

6. The fluid treatment apparatus of claim 1, comprising a hydrogen peroxide tube coupled to a second inlet of the diffuser to provide hydrogen peroxide to the diffuser.

7. The fluid treatment apparatus of claim 6, wherein the diffuser comprises a first porous wall that receives a first one of the ozone and hydrogen peroxide tube and a second porous wall surrounding the first porous wall and that receives between the second and the first porous wall a second one of the ozone and hydrogen peroxide tube.

8. The fluid treatment apparatus of claim 1, wherein the pore size diameter of the porous wall is less than or equal to 10 microns.

9. The fluid treatment apparatus of claim 1, wherein the outlet is connected to a pressure tank to store the treated fluid under a gauge pressure larger than or equal to 2 barg.

10. The fluid treatment apparatus of claim 9, wherein the pressure tank comprises a gas relief valve to allow gas to escape from the pressure tank.

11. The fluid treatment apparatus of claim 1, wherein the porous wall has a pore size diameter that corresponds to a desired bubble size of bubbles that may release in the flow of fluid from the fluid treatment apparatus.

12. The fluid treatment apparatus of claim 1, wherein the flow of fluid along the porous wall has a speed of at least 2 meters per second.

13. The fluid treatment apparatus of claim 1, comprising a pump to create the flow of fluid.

14. A fluid treatment system comprising:
a reservoir that receives fluid, the reservoir comprising:
an inlet that receives the fluid,
at least one chamber, and
an outlet to discharge the treated fluid from the reservoir;
a fluid treatment apparatus to produce a fluid flow comprising ozone that is fed into the reservoir, the fluid treatment apparatus having a diffuser, the diffuser comprising a porous wall and an inlet coupled to an ozone tube to provide ozone to the porous wall, wherein the apparatus is constructed to, in use:
provide a flow of fluid along the surface of the porous wall,
provide a flow comprising ozone to the porous wall, and
add the ozone from the porous wall to the flow of fluid.

15. The system of claim 14, wherein the fluid treatment apparatus receives a hydrogen peroxide tube to produce a flow of fluid comprising hydrogen peroxide.

16. The system of claim 14, wherein the reservoir comprises a plurality of baffled chambers, with at least one of the chambers receiving a flow of fluid comprising ozone from the fluid treatment apparatus.

17. The system of claim 14, wherein the flow of fluid along the surface of the porous wall has a speed of at least 2 meters per second.

18. The system of claim 14, comprising a pump to create the flow of fluid.

19. A method for producing a flow of fluid comprising ozone, the method comprising:
providing a flow of fluid along the surface of a porous wall of a diffuser;
providing a flow comprising ozone to the porous wall; and
adding the ozone from the porous wall to the flow of fluid.

20. The method of claim 19, wherein the flow of fluid along the surface of the porous wall has a speed of at least 2 meters per second.

21. The method of claim 19, comprising using a pump to provide the flow of fluid along the surface of the porous wall.
